(19) United States
(12) Patent Application Publication
(10) Pub. No.: US 2022/0255409 A1
(43) Pub. Date: Aug. 11, 2022

(54) NOISE REDUCTION METHOD BY CUTTING A CORNER OF A TOOTH SHOULDER OF A STATOR OF AN AC TRACTION MOTOR BASED ON INSCRIBED ARC

(71) Applicant: HUNAN UNIVERSITY OF SCIENCE AND TECHNOLOGY, Xiangtan (CN)

(72) Inventors: Xiaoping ZHANG, Xiangtan (CN); Yuxuan GUO, Xiangtan (CN); Zhu ZHANG, Xiangtan (CN); Guanghui ZHU, Xiangtan (CN); Haipeng JIANG, Xiangtan (CN); Hongwei CHEN, Xiangtan (CN)

(21) Appl. No.: 17/168,789

(22) Filed: Feb. 5, 2021

(51) Int. Cl. H02K 15/02; H02K 1/16

(52) U.S. Cl. CPC H02K 15/024; H02K 1/165

(57) ABSTRACT

Provided is a noise reduction method by cutting a corner of a tooth shoulder of a stator of an AC traction motor based on an inscribed arc. Taking a vertex of a corner of the tooth shoulder of the stator as an end point, two points are selected along two sides of the corner of the tooth shoulder of the stator to allow distances from the two points to the end point to be equal. The two points are determined as tangent points D1 and D2 of the inscribed arc. The tangent points D1 and D2 define the inscribed arc along which the corner of the tooth shoulder is cut off.

### TECHNICAL FIELD

The present application relates to a noise reduction method for a motor, in particular to a noise reduction method by cutting a corner of a tooth shoulder of a stator of an alternating current (AC) traction motor based on an inscribed arc.

### BACKGROUND

AC traction motors are widely used due to the advantages of simple and tight structure, reliable operation, high power and high speed, etc. However, much noise will be generated during the operation of such motor, which has an adverse effect on the working environment and human health. In addition, such motor cannot be applied to some special fields. Therefore, it is of great significance to carry out research on the noise reduction of the motor.

The main factor that causes excessive noise of the AC traction motor is the electromagnetic noise generated during the operation. Extensive research has been carried out worldwide on how to reduce the electromagnetic noise of the motor, and methods of, such as changing the motor slot ratio, designing rotor skew for rotors, changing air-gap clearance of the motor, improving assembly techniques for motors and optimizing the control method for the motors, have been proposed. However, methods, that meet the actual noise reduction requirements, are in need.

Yan Li et al (Weakening Approach of the Vibration and Noise Based on the Stator Tooth Chamfering in PMSM with Similar Number of Poles and Slots, TRANSACTIONS OF CHINA ELECTROTECHNICAL SOCIETY) provided a method for reducing electromagnetic noise of a permanent magnet synchronous motor (PMSM) based on the stator tooth chamfering, which is effective. A linear chamfering method is adopted in this document to chamfer the stator tooth, i.e., corners of tooth shoulders of the stator are chamfered by straight lines, which achieves a better noise reduction effect. However, a desired noise reduction effect has not been realized.

### SUMMARY

In view of the above technical problems, the present disclosure provides a noise reduction method by cutting a corner of a tooth shoulder of a stator of an AC traction motor based on an inscribed arc, which is simple in operation and has good noise reduction effect.

Provided is a noise reduction method by cutting a corner of a tooth shoulder of a stator of an AC traction motor based on an inscribed arc, comprising:

1) taking a vertex of the corner of the tooth shoulder of the stator as an end point, selecting two points along two sides of the corner of the tooth shoulder of the stator to allow distances from the two points to the end point to be equal; determining the two points as tangent points D1 and D2 of the inscribed arc; and

2) cutting off the corner of the tooth shoulder along the inscribed arc of the corner of the tooth shoulder defined by the tangent points D1 and D2.

In the step 2, a radius of the inscribed arc is determined according to the distances from the tangent points to the vertex of the corner of the tooth shoulder of the stator and an angle of the corner of the tooth shoulder of the stator:

$$R = L \cdot tan \frac{α}{2} ,$$

wherein R is the radius of the inscribed arc, L is the distance from the tangent points to the vertex of the corner of the tooth shoulder of the stator, and α is an angle of the corner of the tooth shoulder of the stator.

Distances from the tangent points at the two sides of the corner of the tooth shoulder of the stator to the vertex of the corner of the tooth shoulder of the stator are equal.

A distance from each of the tangent points at the two sides of the corner of the tooth shoulder of the stator to the vertex of the corner of the tooth shoulder of the stator is less than a height of a slot of the stator of the AC traction motor.

The method of the present invention has the following beneficial advantages.

For the tooth shoulder of the stator of the AC traction motor, the corner of the tooth shoulder close to the rotor is cut off based on the inscribed arc. The sudden change of magnetic permeability from the tooth shoulder of the stator to the slot of the stator of the motor is reduced without affecting other performance of the motor, so that the amplitude of the low-order electromagnetic waves is significantly suppressed, thereby effectively reducing the electromagnetic noise of the motor.

### BRIEF DESCRIPTION OF THE DRAWINGS

FIG. 1 is a flow chart of a method for cutting a corner of a tooth shoulder of a stator of an AC traction motor based on an inscribed arc according to an embodiment of the present disclosure.

FIG. 2 is a schematic diagram of the stator of the AC traction motor according to an embodiment of the present disclosure.

FIG. 3 schematically shows teeth of the stator of the AC traction motor according to an embodiment of the present disclosure.

FIG. 4 is a schematic diagram of an inscribed arc-based fillet of the tooth shoulder of the stator of the AC traction motor according to an embodiment of the present disclosure.

FIG. 5 is a schematic diagram of a linear chamfer of the tooth shoulder of the stator of the AC traction motor according to an embodiment of the present disclosure.

### DETAILED DESCRIPTION OF EMBODIMENTS

The present disclosure will be further described in detail with reference to the embodiments and the accompanying drawings.

FIG. 2 is a schematic diagram of a stator of an AC traction motor according to an embodiment of the present disclosure. In the drawings, numeral 1 indicates a stator core; numeral 2 indicates a yoke of the stator core; and numeral 3 indicates a tooth of the stator core.

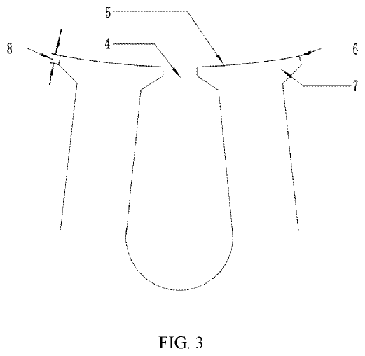

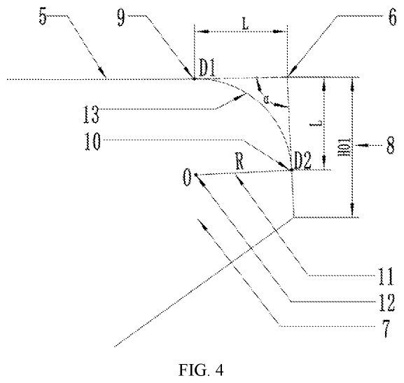

FIG. 3 schematically shows teeth of the stator of the AC traction motor according to an embodiment of the present disclosure. FIG. 4 is a schematic diagram of an inscribed arc-based fillet of the tooth shoulder of the stator of the AC traction motor according to an embodiment of the present disclosure. In the drawings, numeral 4 indicates a slot of the stator; numeral 5 indicates a tooth top of the stator; numeral 6 indicates a vertex of the tooth shoulder; numeral 7 indicates the tooth shoulder; numeral 8 indicates a height Hoi of the slot; numerals 9 and 10 are tangent points D1 and D2 of the inscribed arc, respectively; numeral 11 is a radius R of the inscribed arc; numeral 12 indicates a center O of the inscribed arc; and numeral 13 indicates the inscribed arc.

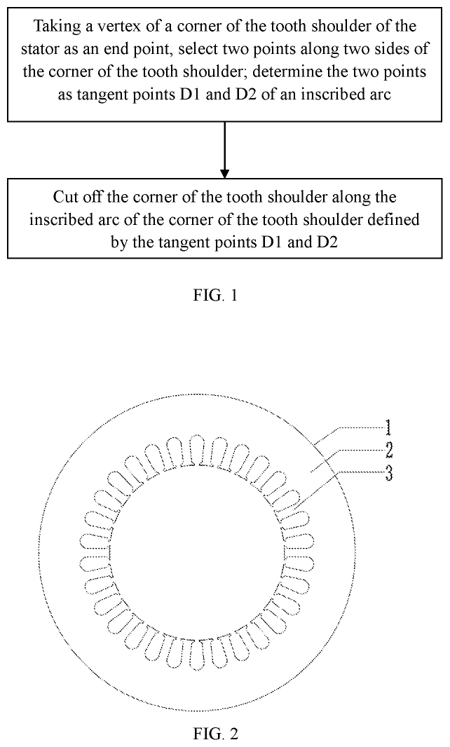

In this embodiment, the electromagnetic noise of the motor is reduced by cutting a corner of the tooth shoulders 7 located on both sides of the tooth 3 of the stator core without changing the structure of the rotor. As shown in FIG. 1, the method includes the following steps.

1) The vertex 6 of the corner of the tooth shoulder of the stator is defined as the end point. Two points are selected along two sides of the corner of the tooth shoulder of the stator to allow distances from the two points to the end point to be equal. The two points are determined as tangent points D1 and D2 of the inscribed arc 13.

2) The inscribed arc 13 of the tooth shoulder is determined through the tangent points D1 and D2, and the corner of the tooth shoulder is cut off along the inscribed arc 13.

In the step 2, a radius of the inscribed arc is determined according to the distance from each of the two tangent points to the vertex of the corner of the tooth shoulder of the stator, and an angle of the corner of the tooth shoulder of the stator:

$$R = L \cdot tan \frac{α}{2} ,$$

wherein R is the radius of the inscribed arc 13, L is the distance from the tangent points to the vertex of the corner of the tooth shoulder of the stator; the tangent points at the two sides of the corner of the tooth shoulder of the stator to the vertex of the corner of the tooth shoulder of the stator are equal; a distance from each of the two tangent points at the two sides of the corner of the tooth shoulder of the stator to the vertex of the corner of the tooth shoulder of the stator is less than a height of the slot of the stator of the AC traction motor; and α is an angle of the corner of the tooth shoulder of the stator.

For teeth of the stator core of the motor, the number of the corner of tooth shoulder to be cut can be determined according to actual needs.

An AC traction motor is taken for noise analysis, and parameters thereof are shown in Table 1.

TABLE 1

| | | | | Number | | |
|---|---|---|---|---|---|---|
| | | | Number | of | Number | |
| | | Rated | of pole | stator | of rotor | Slot |
| Frequency | Voltage | power | pairs | slots | slots | height |
| 50 Hz | 380 V | 5.5 kW | 1 | 30 | 26 | 0.8 mm |

First, an analysis software ANSYS is adopted to analyze the noise of the above-mentioned motor without cutting the corner. Specifically, an electromagnetic field of the motor is analyzed through a Maxwell module of the ANSYS to obtain radial electromagnetic force data of the motor. Then, the radial electromagnetic force data is loaded into a 3D motor model in a Harmonic Response module for harmonic response analysis. Then, the obtained data is coupled to a 3D sound field model in a Harmonic Acoustic module for sound field simulation. Finally, the noise data is obtained through post-processing. Based on the above method and the parameters shown in Table 1, the noise data of the motor is analyzed to be 67.904 dB.

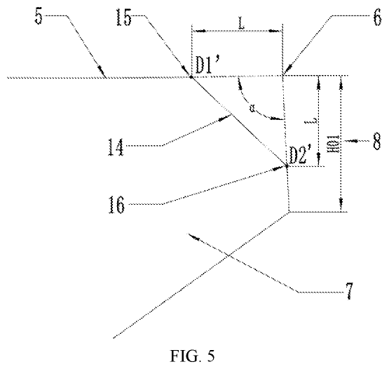

In this embodiment, for the above motor, corners of tooth shoulder at two sides of the stator tooth close to the rotor is cut off along the inscribed arc, and the noise analysis is performed through the analysis software using the above method. Meanwhile, in terms of the noise of the motor, the linear chamfering in the document “Weakening Approach of the Vibration and Noise Based on the Stator Tooth Chamfering in PMSM with Similar Number of Poles and Slots” is compared to the inscribed arc-based cutting method. FIG. 4 is a schematic diagram of an inscribed arc-based fillet of the tooth shoulder of the stator of the AC traction motor according to an embodiment of the present disclosure. FIG. 5 is a schematic diagram of a linear chamfer of the tooth shoulder of the stator of the AC traction motor according to an embodiment of the present disclosure. Numeral 6 indicates the vertex of the tooth shoulder; numeral 7 indicates the tooth shoulder; numeral 8 indicates the height H₀₁ of the slot; numeral 14 indicates a line (straight line) for cutting the corner; numerals 15 and 16 are tangent points D1′ and D2′ of the inscribed arc, respectively, i.e., the intersections of the line and the sides of the tooth shoulder of the stator.

Specifically, two sets of data of distances from the vertex 6 of the corner of tooth shoulder of the motor to the cutting point (tangent point) on both sides are selected, where the distances from the vertex 6 of the corner of tooth shoulder of the motor to the cutting point (tangent point) on both sides are equal, and any distance, such as 0.4 mm and 0.6 mm, can be selected. The inscribed arc based cutting method and the linear chamfering method are adopted to cut the tooth shoulder, respectively, and then the analysis software ANSYS is used for noise analysis to obtain corresponding noise data shown in Table 2.

TABLE 2

| | Distance from | Linear chamfering | Inscribed |
|---|---|---|---|
| | cutting | method | arc-based cutting |
| No. | points to vertex (mm) | (dB) | method (dB) |
| 1 | 0.4 | 52.793 | 47.391 |
| 2 | 0.6 | 48.626 | 44.636 |

As can be seen from the Table 2, the noise of the motor corresponding to the linear chamfering method and the inscribed arc-based cutting method is reduced relative to the noise of the motor that is not cut, and reduction percentages of noise of the motor using the linear chamfering method and the inscribed arc-based cutting method are shown in Table 3.

TABLE 3

| | Distance from | Linear chamfering | Inscribed |
|---|---|---|---|
| | cutting | method | arc based cutting |
| No. | points to vertex (mm) | (%) | method (%) |
| 1 | 0.4 | 22.25% | 30.20% |
| 2 | 0.6 | 28.39% | 34.27% |

As can be seen from Table 2 and Table 3, after a corner of the tooth shoulder of the stator of the AC traction motor is cut off using the inscribed arc-based cutting method, the noise of the AC traction motor is reduced relative to that of the motor cut by the linear chamfering method. Therefore, the inscribed arc-based cutting method has a better noise reduction effect.

What is claimed is:

1. A noise reduction method by cutting a corner of a tooth shoulder of a stator of an alternating current (AC) traction motor based on an inscribed arc, comprising:
1) taking a vertex of a corner of the tooth shoulder of the stator as an end point, selecting two points along two sides of the corner of the tooth shoulder of the stator to allow distances from the two points to the end point to be equal; determining the two points as tangent points D1 and D2 of the inscribed arc; and
2) cutting off the corner of the tooth shoulder along the inscribed arc of the corner of the tooth shoulder defined by the tangent points D1 and D2.

2. The method of claim 1, wherein in the step 2, a radius of the inscribed arc is determined according to the distances from the tangent points to the vertex of the corner of the tooth shoulder of the stator and an angle of the corner of the tooth shoulder of the stator:
$$R = L \cdot tan \frac{α}{2} ,$$
wherein R is the radius of the inscribed arc, L is the distance from the tangent points to the vertex of the corner of the tooth shoulder of the stator, and α is an angle of the corner of the tooth shoulder of the stator.

3. The method of claim 1, wherein distances from the tangent points at the two sides of the corner of the tooth shoulder of the stator to the vertex of the corner of the tooth shoulder of the stator are equal.

4. The method of claim 1, wherein a distance from each of the tangent points at the two sides of the corner of the tooth shoulder of the stator to the vertex of the corner of the tooth shoulder of the stator is less than a height of a slot of the stator of the AC traction motor.
